(19) United States
(12) Patent Application Publication
(10) Pub. No.: US 2024/0265797 A1
(43) Pub. Date: Aug. 8, 2024

(54) TV Remote Locator

(71) Applicant: Claude Hasty, Mastic Beach, NY (US)

(72) Inventor: Claude Hasty, Mastic Beach, NY (US)

(21) Appl. No.: 18/106,602

(22) Filed: Feb. 7, 2023

(51) Int. Cl. G08B 21/24

(52) U.S. Cl. CPC G08B 21/24

(57) ABSTRACT

The disclosure, also known as Hasty Button, is the only product of its kind that allows users to locate their remote controls directly from their televisions by using a cutting-edge sound alarm technology. Since most of us have multiple remotes for our TVs, video players and amplifiers, a serial, a parallel broadcast and a hybrid mode of alarming is developed and claimed. This unprecedented product is uniquely designed with durable, high-quality materials to ensure long-term sustainability; ultimately, providing an improved addition to a televisions structural function.

### BACKGROUND

Losing a remote control is a common problem, especially, since new smart TV controls are even smaller and easier to misplace in comparison to older designs. Not only is losing a remote control annoying and stressful, as its size permits it to get lost in odd places, but finding it also utilizes time that could be better spent relaxing and watching programs. There have been no products available as original equipment or as an aftermarket to address this problem.

An apparatus designed to assist individuals to ensure they do not lose their TV remote is not being met by any known device or system at present. There have been no products available as original equipment or as an aftermarket to address this problem either.

### SUMMARY OF THE INVENTION

The main purpose of the TV Remote Locator is to provide users with a method of quickly locating a first misplaced remote for a first device, a second misplaced remote for the first device or for a second device, a third misplaced remote for the first device or for the second device or for a third device in a serial mode or in a parallel broadcasting mode. Activation and deactivation of alarms for each remote is also accomplished in a serial mode and in a parallel mode based on control circuits and management thereof.

An electronic system for lose and seek of multiple misplaced items, comprises multiple remote locator buttons each having transceiver circuits, multiple discrete alarms each having transceiving circuits configured to communicate with the plurality of remote locator buttons and respective controlling circuits in each of the plurality of remote locator buttons configured to activate and deactivate a respective one of the plurality of discrete alarms in a serial mode and in a parallel mode and in a hybrid mode for mix and match lose and seek.

### BRIEF DESCRIPTION OF THE DRAWINGS

FIG. 1 is a front elevational view of the TV Remote Locator in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

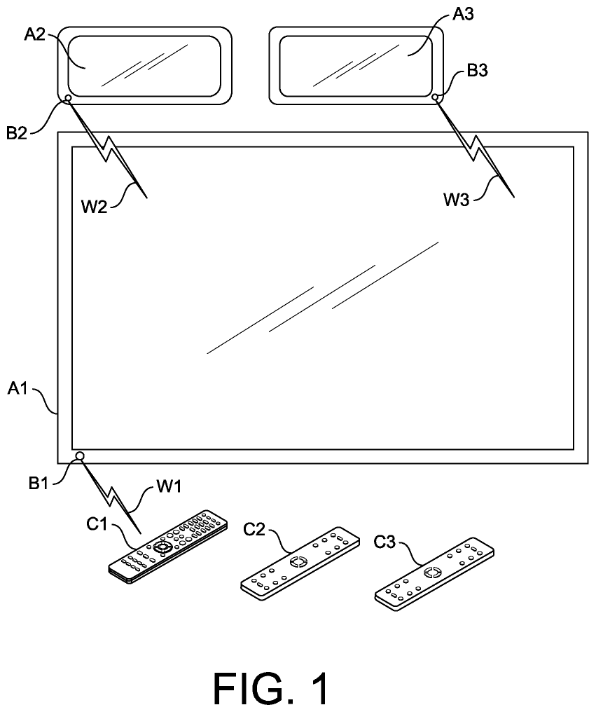

FIG. 1 is a front elevational view of the TV Remote Locator showing: TV referenced as A1, a second device A2 such as a VCR or DVD player and a third device A3 such as an amplifier etc. A respective remote locator button referenced as B1, B2 and B3 placed on respective devices are used to activate and to deactivate an alarm on respective remote controls (sounds off when locator button is pressed) referenced as C1, C2 and C3, in accordance with an embodiment of the present disclosure. Activation of the alarms is accomplished in serial mode and in a parallel broadcasting mode for each remote at a time or for all remotes at once as claimed and as recited and taught herein. The electromagnetic waves W1, W2, and W3 are generated individually and all together at once based on the mode chosen by the user and implemented in state machine control circuits. The waves W1, W2 and W3 are generated in the infrared spectrum, in the Bluetooth spectrum and in the radio spectrum and otherwise as price point and design constraints dictate to market demands.

The present disclosed TV Remote Locator, also known as “Hasty Button”, offers a modern adaptation for electronics whereas it emits an audible alert from the remote to ensure users are able to easily and quickly find their lost TV control, at all times. Expanding on the initial design of an average television, the Hasty Button introduces a novel button built into a television unit that is synchronized with its complementary remote control; thereby, enabling the primary control to initiate a sound and light when the button is pressed. Once the button is initiated on the TV monitor, users will be able to immediately detect their remote by following the sound, effectively, minimizing the hassle of searching for the device and permitting more time for enjoying TB viewership. This innovative, top-quality product enhances the functionality of both a traditional television and remote control.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. An electronic system for lose and seek of multiple misplaced items, comprising:
a plurality of remote locator buttons each having transceiver circuits;
a plurality of discrete alarms each having transceiving circuits configured to communicate with the plurality of remote locator buttons;
a plurality of controlling circuits in each of the plurality of remote locator buttons configured to activate and deactivate a respective one of the plurality of discrete alarms in a serial mode and in a parallel mode.

2. The electronic system of claim 1, wherein each of the plurality of locator buttons is disposed on one of a TV, a DVD player, a hard disk drive, a solid state drive and an amplifier.

3. The electronic system of claim 1, wherein each of the plurality of discrete alarms is disposed on one of a remote control for a respective TV, a DVD player, a hard disk drive, a solid state drive and an amplifier.

4. The electronic system of claim 1, wherein each of the plurality of controlling circuits is a state machine, a microcontroller and a microprocessor circuit.

5. The electronic system of claim 1, wherein each transceiver circuit of the plurality of remote locator buttons is configured to generate an electromagnetic wave received by a transceiving circuit of one of the plurality of discrete alarms via the respective plurality of controlling circuits.

6. The electronic system of claim 1, wherein each transceiver circuit of the plurality of remote locator buttons is configured to generate an electromagnetic wave received by all transceiving circuits at once of the plurality of discrete alarms via the respective plurality of controlling circuits.

7. The electronic system of claim 1, wherein each of the plurality of discrete alarms is an audible alarm.

8. The electronic system of claim 1, wherein each of the plurality of discrete alarms is a vibrating alarm.

9. The electronic system of claim 1, wherein each of the plurality of discrete alarms is a visual lighted alarm.

10. The electronic system of claim 1, wherein each of the plurality of controlling circuits deactivates a respective one of the plurality of discrete alarms one at a time in a serial mode.

11. The electronic system of claim 1, wherein each of the plurality of controlling circuits deactivates all of the plurality of discrete alarms at once in a parallel mode.

12. The electronic system of claim 1, wherein each of the plurality of controlling circuits activates a respective one of the plurality of discrete alarms one at a time in a serial mode.

13. The electronic system of claim 1, wherein each of the plurality of controlling circuits activates all of the plurality of discrete alarms at once in a parallel mode.

14. The electronic system of claim 1, wherein each of the plurality of controlling circuits is further programmable to activate and to deactivate the alarms in groups of more than one but less than all in a hybrid mode.

15. The electronic system of claim 1, wherein the system is an aftermarket system configured to attach to original equipment manufactured devices.
